(19) United States
(12) Patent Application Publication
(10) Pub. No.: US 2014/0324824 A1
(43) Pub. Date: Oct. 30, 2014

(54) Search in Social Networks

(71) Applicant: GFACE GMBH, Frankfurt/Main (DE)

(72) Inventor: Cevat Yerli, Frankfurt/Main (DE)

(21) Appl. No.: 13/870,923

(22) Filed: Apr. 25, 2013

(51) Int. Cl. G06F 17/30

(52) U.S. Cl. CPC G06F 17/30554
USPC 707/722

(57) ABSTRACT

A computer-implemented method in a social network for retrieving social media is provided, wherein the method comprises presenting, to a first user, a list of available perspectives of different owners; receiving, from the first user, a selection of a perspective from the list of available perspectives; carrying out a search based on the selected perspective to obtain search results associated with social media; and presenting, to the first user, the search results. Furthermore, an apparatus allowing a user of a social network to retrieve social media is defined.

### FIELD

The present disclosure relates to a computer-implemented method, an apparatus, and a machine-readable medium for allowing a user of a social network to retrieve social media.

### BACKGROUND

Commonly, a user in a computer-implemented network, such as a social network, may trigger a search on a specific topic by entering a search term. The system will then carry out a search for relevant items based on the entered search term and, possibly, further based on search terms previously entered by the user. The search results provided to the user are thus based on whatever search term he or she has entered and, possibly, on his or her previous interactions with the network.

### SUMMARY

It is therefore an objective of the present disclosure to provide the user with search results that are relevant for his or her search, which may not have been retrieved using known techniques. In particular, the present disclosure utilizes the connections of the user within the social network and the user's membership in one or more social groups to provide more relevant search results to the user.

In a first aspect, the present disclosure provides a computer-implemented method in a social network for retrieving social media, comprising: presenting, to a first user, a list of available perspectives of different owners; receiving, from the first user, a selection of a perspective from the list of available perspectives; carrying out a search based on the selected perspective to obtain search results associated with social media; and presenting, to the first user, the search results.

In the present disclosure, the term social media may refer to any type of media content, such as one or more texts, images, videos, audio files, user profiles, blogs, ebooks, and/or web sites, as well as people, such as one or more other users, organizations, and/or social groups; and/or products, services, articles, books, etc. The present disclosure allows the user to select one of several different available perspectives. In some embodiments, available perspectives may include, but are not limited to, the first user's own perspective, a friend's perspective, and/or a group perspective. By selecting one of the available perspectives, the user may be provided with social media, or indications of social media, such as possible new connections and new friends, which are not easily found using known systems and methods.

While, in some embodiments, the perspectives on the list of available perspectives may each belong to a different owner, in an alternative embodiment, the list comprises at least three available perspectives, and two of these belong to the same owner. In some embodiments, the list of available perspectives is the same for all users of the social network. However, in many embodiments, the list of available perspectives will be different for different users of the social network.

In some embodiments, the first user may select a perspective from the list of available perspectives using at least one drop-down list or by clicking on an icon or text associated with a perspective of a user, organization, or social group.

In an illustrative embodiment, the method further comprises: receiving, from the first user, at least one search term and, in this embodiment, the search may further be carried out based on the at least one search term. In this embodiment, the first user may specify one or more search terms, e.g., a search word or a search phrase. The search will then be carried out based on both the selected perspective and the search term. In order to be able to enter a search term, the user may be provided with a user interface containing an input field, into which the user may enter the search term.

Alternatively or additionally, one or more search terms may be automatically generated based on the interests of the first user, a website currently or recently visited by the first user, and/or social media that the first user currently or recently engaged in. In some embodiments, one or more search terms are automatically generated when the first user clicks on a button, an icon, or the like, representing one or more specific interests, genres, texts, images, videos, audio files, books, articles, products, services, etc.

In particular, a search may also be carried out without the user explicitly specifying a search term. In that case, a custom default algorithm may be employed, taking into account the first user's interests. For example, search terms previously entered by the user, existing connections of the first user in the social network, and/or content previously entered by the first user may be used by the algorithm when carrying out the search. More generally, the method may comprise determining the first user's interests based on the first user's previous and/or current activities in the social network and/or when browsing the Internet. The method may, in some embodiments, further suggest one or more search terms based on the determined user interests, such that the user may select one or more of the suggested search terms to be used when carrying out the search. Additionally or alternatively, the method may utilize the determined user interests when carrying out the search. E.g., the method may comprise carrying out the search based on the selected perspective and on the determined user interests. In order to determine the first user's interests, the method may, e.g., comprise using one or more cookies. The one or more cookies may be placed on an access device that the first user employs to enter the social network. The access device may comprise, e.g., a laptop, a mobile phone, a PC, a tablet PC, or the like.

When a search term is received from or selected by the user, or otherwise determined, the method calculates the best matches according to the selected perspective and the search term. The best matches are then presented to the first user as search results.

According to an illustrative embodiment, each of the available perspectives is associated with a set of social media and the search is carried out based on the set of social media of the selected perspective. In some instances, one or more of the available perspectives are associated with a set of social media and, when the respective perspective is selected by the first user, the search is carried out within the set of social media associated with the selected perspective. In the latter case, the search results may be identical to or may be a subset of the set of social media associated with the selected perspective.

It is, in particular, preferred that the set of social media associated with each perspective of the list of available perspectives comprises social media that the owner of the respective perspective previously engaged in.

For example, when the selected perspective is owned by a user that has previously engaged in a set of music videos, the search results may comprise a subset or all of these music videos. Similarly, when the selected perspective is owned by a group of users, the set of social media associated with that perspective may be a set of media that the members of that group previously engaged in. In some instances, for a particular set of social media, or a subset thereof, to be associated with a perspective, the owner of that perspective must have engaged themselves in that social media, e.g., at least once, at least twice or, preferably, at least five times.

In some embodiments, the list of perspectives that are available for the first user comprises perspectives of the first user himself or herself, the first user's direct friends, and social groups that the first user is a member of. Additionally or alternatively, the list of available perspectives may comprise one or more perspectives of social groups or users that have indicated that their perspective shall also be available to other users.

In some embodiments, the user may decide that his or her own perspective shall also be available to any other user, or only to his or her friends, only to friends of his or her friends, etc. For example, the user may decide that his or her own perspective shall also be available to members of one or more social groups that the first user may be a member of. In some embodiments, the first user may individually decide to share his or her perspective with other users and/or group of users, e.g., by selecting the one or more users and/or groups from a list of users or groups, respectively.

In an illustrative embodiment, each of the available perspectives is associated with a respective set of interests, topics, and/or search terms. In this way, the perspective defines the input parameters for the search that is to be carried out. For example, when the first user has a friend in the social network who is a fan of rock music, and the first user selects the perspective of that friend, then the search is carried out from the perspective of that friend, e.g., based on the interests and social media that the first user's friend previously engaged in.

According to an illustrative embodiment, the owners of each of the available perspectives are users of the social network and/or groups of users of the social network.

In an illustrative embodiment, the list of available perspectives comprises at least two of the following: a perspective associated with the first user, a perspective associated with a second user, preferably connected with the first user via the social network, and a perspective associated with a social group. The second user may, in particular, be connected with the first user because the second user is a friend of the first user in the social network. In some instances, a connection between two users may require a direct connection between the two users in the social network. Additionally or alternatively, a connection between two users may allow that a shortest path between the two users in the social network is via one or more additional users.

The social group may be, e.g., a social group that the first user has joined. Selecting a group perspective may comprise carrying out the search based on the common or aggregated interests or topics of the members of said group. The common interests or topics may be automatically detected by evaluating the interactions of members of said group, the social media that members of said group engaged in, or the like. In some embodiments, a group perspective may be associated with a set of keywords that were entered by the members in previous interactions of the members of said group. Alternatively or additionally, the group perspective may be associated with social media that at least two or more members of the group previously engaged in.

According to an illustrative embodiment, the search results are presented in an order that is determined based on the selected perspective.

In an illustrative embodiment, the search is carried out in real time. Hence, social media only recently consumed (e.g., viewed) by the first user's friends or groups are taken into account when providing the first user with search results.

In a further aspect, the present disclosure provides an apparatus, comprising: an input/output device to couple to at least one user access device of a first user; a database storing sets of indications of social media, the sets of indications being associated with at least two different perspectives of a list of available perspectives of at least two different owners; circuitry coupled to the input/output device and the database, and adapted to: transmit, to the at least one user access device, the list of available perspectives; receive, from the at least one user access device, a selection of a perspective from the list of available perspectives; carry out a search based on the selected perspective to obtain search results associated with social media; and transmit, to the at least one user access device, the search results.

As described above, the user access device may refer to any device that the first user employs to enter and interact with the social network, such as a mobile phone, a laptop, a tablet PC, etc.

In some embodiments, the apparatus may comprise a computer such as a network server. The input/output device may, in particular, be adapted to couple to the at least one user access device via the Internet. To this effect, the input/output device may comprise an interface device such as a network adapter.

According to an illustrative embodiment, the apparatus is further adapted to place a cookie on the at least one user access device to gather information about the social media that the first user engages in. In this embodiment, the apparatus is able to gather information about the social media that the first user engages in, and to process the information to elucidate the first user's perspective and to store the processed information in the database. When subsequently carrying out a search based on the first user's perspective, the circuitry may then use the processed information stored in the database to obtain or improve the search results.

In a further aspect, the present disclosure provides a machine-readable medium (e.g., a non-transitory medium such as a memory or storage medium) having instructions stored thereon that, when executed by a computer, result in the computer performing a method of: presenting, to a first user, a list of available perspectives of different owners; receiving, from the first user, a selection of a perspective from the list of available perspectives; carrying out a search based on the selected perspective to obtain search results associated with social media; and presenting, to the first user, the search results.

### DESCRIPTION OF THE DRAWINGS

Aspects and benefits of the present disclosure are best understood from the following detailed description when read in combination with the accompanying figures.

FIG. 1 shows a user interface presenting search results in a default state;

FIG. 2 shows a user interface allowing the user to select a perspective of one of a list of social groups; and

FIG. 3 shows a user interface presenting a search result based on a selected user's perspective.

### DETAILED DESCRIPTION

Features and advantages of the present invention are, in the following, described in terms of one or more illustrative embodiments. The description is to be understood as being illustrative rather than limiting.

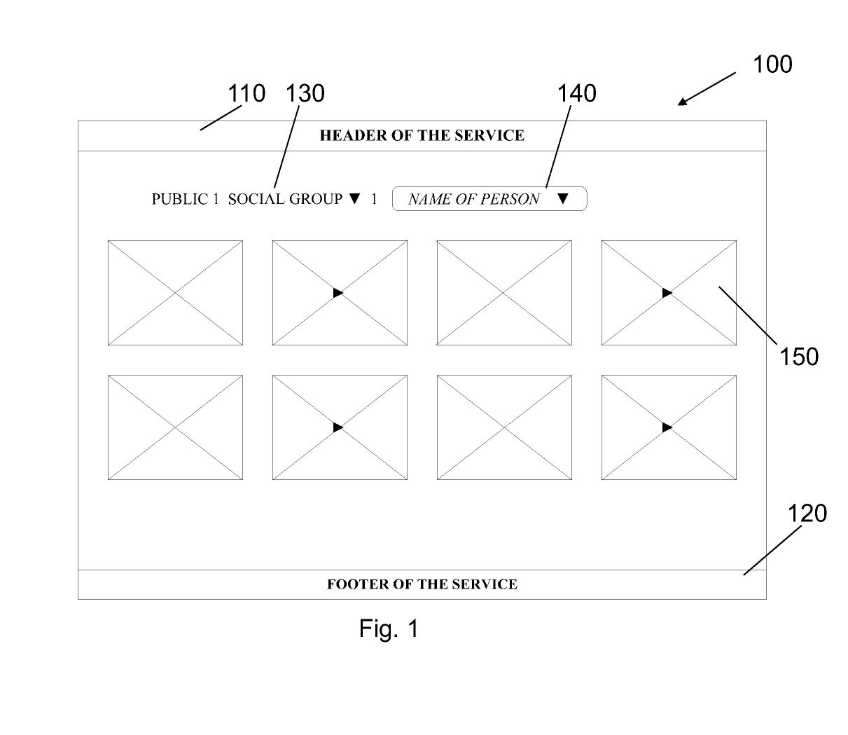

FIG. 1 shows a user interface presenting search results that are obtained in a default state. When a user sets no specific interests and no specific search term has been entered, then the system is configured in a default state. In the default state, the social media displayed to a user are based on the user's own interests, e.g., interests from their own profile. An example of search results presented in the default state is illustrated in FIG. 1. FIG. 1 shows a user interface 100 that is shown to a user and that presents search results 150 from the perspective of that user. The user interface 100 comprises a top section 110, in which the header of the service may be provided. The header of the service may, for example, refer to a name of the current service, a name of the user, etc. Moreover, the user interface 100 includes a bottom section 120 providing a footer of the service. The footer of the service may, for example, include a name of a presently executed or available service, a current time, a current date, a current connection status, news, etc.

In a central section of the user interface 100, search results 150 are presented. In order to provide the search results, the system may, for example, use the top three interest items of the user's interest cloud-profile. Using interest items of the user, a custom default algorithm may be run to obtain search results. The custom default algorithm may, in some embodiments, be based on publicly available interests, or “seeds” as defined in U.S. patent application Ser. No. 13/609,046, “Management of Online Content in a Network,” the disclosure of which is incorporated herein by reference.

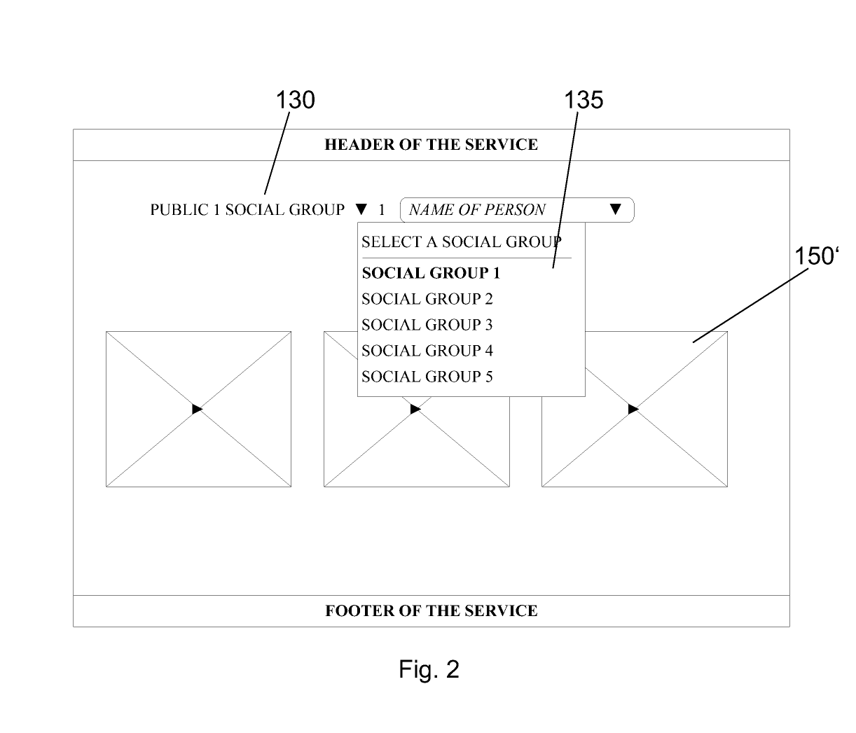

Once the system has been launched, the user may use a drop-down list included in the user interface 100 to select a perspective different from the default state, if he or she so wishes. When the user toggles a button 130 labeled “Public 1 Social Group” included in the user interface 100 of FIG. 1, he or she is provided with a drop-down list 135 of different social groups, as illustrated in FIG. 2. In some instances, these social group perspectives may be available to the user because the user is a member of these social groups. When the user selects one of the available social groups displayed in the drop-down list 135, such as “SOCIAL GROUP 1,” the system automatically rearranges the presented search results 150′ in real time. In this configuration, all the social media that members of the selected social group have engaged with are taken into account by the custom algorithm when calculating the best matches/connections for the selected perspective to obtain the search results 150′. Similar to the search results 150, the search results 150′ may be associated with social media. As can be seen from FIG. 2, the search results 150′ provided when selecting “SOCIAL GROUP 1” in the drop-down list 135 are different (e.g., there are fewer results presented), from the search results 150 that are presented in the default state of FIG. 1, in which the user's own perspective was used to obtain the search results 150.

In some embodiments, at least one member of the selected social group must have engaged in a social medium for that social medium to be included in the set of presented search results 150′. More generally, the presented search results 150′ obtained based on the perspective of the selected social group may be based on the gathered interests or a common interest of all members of the selected group.

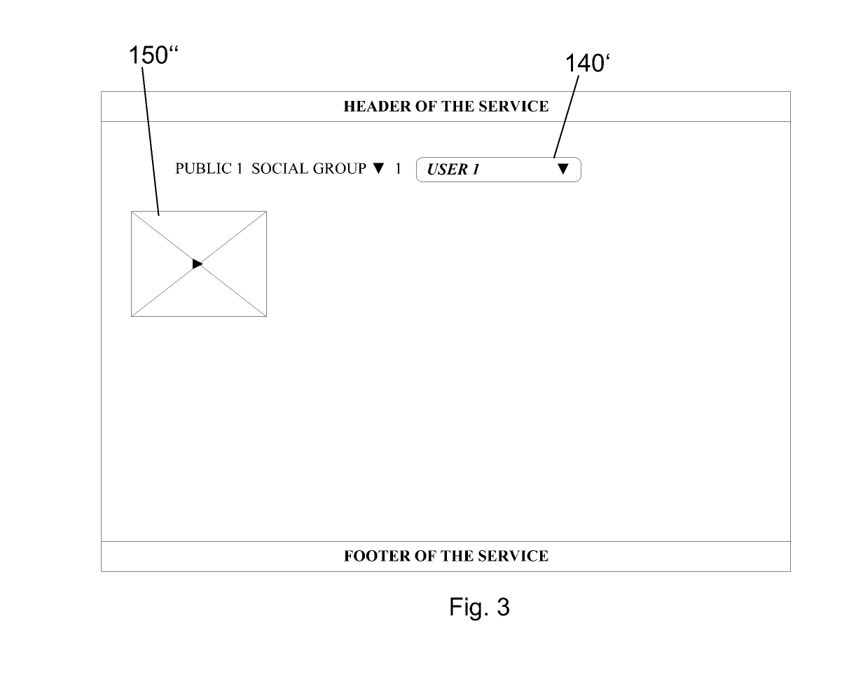

Similarly, using field 140 in FIG. 1, the user may select the name of a person in order to switch to the perspective of that person. For example, when the user selects the name of “USER 1” in the field 140, he or she is provided with a user interface as illustrated in FIG. 3. Here, the name of “USER 1” is shown in field 140′. In this configuration, the perspective of User 1 has been selected and the system carries out a search based on User 1's perspective. All the social media that User 1 has previously engaged with in relation to the search topic are displayed, generally indicated by reference sign 150″.

In addition to selecting a specific social group or a user perspective, the user may enter one or more search terms (not shown) to modify the displayed search results. To this effect, the user interface may, in some embodiments, include an additional field to enter one or more search terms. When a particular search term has been entered into that field, the system carries out a real-time search based on the entered search term and the selected perspective. In some embodiments (not shown), one or more search terms may be automatically used in the search, or may be suggested to the user, e.g., when the user clicks on a specific field or icon representing a particular interest, genre, title, image, text, video, audio file, etc.

While the described embodiment provides two separate drop-down lists 130, 140 for selection of a perspective, the skilled person will readily understand that, alternatively or additionally, other means for selecting a perspective may be utilized. For example, a single list, such as a single drop-down list, may be provided that includes both individual user perspectives and social group perspectives.

In summary, the described methods and apparatus may, e.g., provide for four different settings with regard to perspectives. In a first, or default, setting, a user has not set any specific interest(s). The system sets to a default mode, where the social media that are presented to the user reflect the user's own particular interests. Such a setting is illustrated in FIG. 1.

In a second setting, a user may specifically select a single user perspective. For example, a user may trigger a search based on the search term “comics,” either by explicitly entering the search term “comics” or by clicking on an icon representing comics, either a particular one or comics in general. In the non-modified perspective of a single user, the output is that of their own social media, e.g., the social media they previously engaged in. In other words, they see their own interests in relation to the selected search topic or entered search term. In the above example, the search results may comprise social media corresponding to User 1's interests and further relating to the entered search term “comics.”

In a third setting, a user may select a group perspective. For example, the user may search for a particular topic, for example, “BMW.” When the user has selected a particular social group's perspective, the system, using the custom algorithm, filters accordingly and presents the social media that best represent “BMW,” but from the selected group's particular perspective. For example, the group in question may have a particular interest in convertibles, racing cars, and cars from a particular time period (e.g., 1960 to 1970). Hence, the social media presented to the user would reflect those particular specific interest strains, all related to “BMW.” This setting allows a user to make new “social media” connections, i.e., a new connection to content and/or people.

In a fourth setting, the user may select another user's perspective, such as a perspective of one of the user's friends. In this case, User 1 may, for example, search by the topic “gaming.” When User 1 selects his or her friend's perspective, for example User 2's perspective, the system works in the same way as specified above and uses the custom algorithm to calculate the best matches in regard to the social media that User 2 has engaged with, but in relation to the interests selected by User 1, e.g., in relation to the search term “gaming.” This provides for new media connections being proposed and made available to User 1, taking into account the interests and existing connections of User 2.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method in a social network for retrieving social media, comprising:
presenting, to a first user, a list of available perspectives of different owners;
receiving, from the first user, a selection of a perspective from the list of available perspectives;
carrying out a search based on the selected perspective to obtain search results associated with social media; and
presenting, to the first user, the search results.

2. The computer-implemented method of claim 1, further comprising:
receiving, from the first user, at least one search term, wherein the search is further carried out based on the at least one search term.

3. The computer-implemented method of claim 1, wherein each of the available perspectives is associated with a set of social media, and wherein the search is carried out based on the set of social media associated with the selected perspective.

4. The computer-implemented method of claim 3, wherein the set of social media associated with each of the available perspectives comprises social media that the owner of the respective perspective previously engaged with.

5. The computer-implemented method of claim 1, wherein each of the available perspectives is associated with a respective set of interests, topics, and/or search terms.

6. The computer-implemented method of claim 1, wherein the owners of each of the available perspectives are users of the social network and/or groups of users of the social network.

7. The computer-implemented method of claim 1, wherein the list of available perspectives comprises at least two of the following: a perspective associated with the first user, a perspective associated with a second user, and a perspective associated with a social group.

8. The computer-implemented method of claim 1, wherein the search results are presented in an order that is determined based on the selected perspective.

9. The computer-implemented method of claim 1, wherein the search is carried out in real time.

10. An apparatus, comprising:
an input/output device coupled to at least one user access device of a first user;
a database storing sets of indications of social media, the sets of indications being associated with at least two different perspectives of a list of available perspectives of at least two different owners;
circuitry coupled to the input/output device and the database, and adapted to:
transmit, to the at least one user access device, the list of available perspectives;
receive, from the at least one user access device, a selection of a perspective from the list of available perspectives;
carry out a search based on the selected perspective to obtain search results associated with social media; and
transmit, to the at least one user access device, the search results.

11. The apparatus of claim 10, wherein the input/output device is adapted to be coupled to the at least one user access device via the Internet.

12. The apparatus of claim 10, wherein the apparatus is further adapted to place a cookie on the at least one user access device to gather information about the social media that the first user engages in.

13. A machine-readable medium having instructions stored thereon that, when executed by a computer, result in the computer performing a method of:
presenting, to a first user, a list of available perspectives of different owners;
receiving, from the first user, a selection of a perspective from the list of available perspectives;
carrying out a search based on the selected perspective to obtain search results associated with social media; and
presenting, to the first user, the search results.
